(19) United States
(12) Patent Application Publication
(10) Pub. No.: US 2019/0315391 A1
(43) Pub. Date: Oct. 17, 2019

(54) BALL SCREW DRIVE OF AN ELECTROMECHANICAL SERVO-ASSISTED POWER STEERING SYSTEM HAVING INTEGRATED ANGULAR BALL BEARING AND COMPENSATION FOR DIFFERING THERMAL EXPANSION

(71) Applicants: THYSSENKRUPP PRESTA AG, Eschen (LI); thyssenkrupp AG, Essen (DE)

(72) Inventors: András ILLÉS, Gams (CH); Wolfram RAITHER, Buchs (CH)

(73) Assignees: THYSSENKRUPP PRESTA AG, Eschen (LI); thyssenkrupp AG, Essen (DE)

(21) Appl. No.: 16/309,499

(22) PCT Filed: Jun. 22, 2017
(86) PCT No.: PCT/EP2017/065363

§ 371 Date: Dec. 13, 2018

(30) Foreign Application Priority Data
Jun. 22, 2016 (DE) 10 2016 007 540.6

(51) Int. Cl. B62D 5/04; F16H 25/22; F16H 25/24

(52) U.S. Cl. CPC B62D 5/0448; B62D 5/0403; F16H 2025/2081; F16H 25/24; F16H 25/2204

(57) ABSTRACT

An electromechanical servo-assisted power steering system may include a servo motor that drives an axially displaceable structural element by way of a ball nut that is rotatably supported in a bearing in a housing. The ball nut may be engaged with a threaded spindle constructed on the axially displaceable structural element. The bearing may be a dual-row angular ball bearing having at least one bearing inner ring and at least one bearing outer ring. The at least one bearing outer ring may be received in a sleeve that is arranged in a bearing seat of the housing.

The present invention relates to an electromechanical servo-assisted power steering system having the features of the preamble of claim 1.

In electromechanical servo-assisted power steering systems, there is produced via an electric motor a torque which is transmitted to a gear mechanism and which at that location is superimposed on the steering torque introduced by the driver.

A generic electromechanical servo-assisted power steering system has a servomotor which acts on a ball nut of a ball screw drive. The ball nut is in engagement via revolving balls with a ball screw which is arranged on the outer periphery of a toothed rack which is part of a rack-and-pinion steering system. A rotation of the ball nut brings about an axial displacement of the toothed rack, whereby a steering movement of the driver is supported.

Preferably, the ball screw drive is coupled to the electric motor by means of a toothed belt.

The ball nut is rotatably supported in a ball bearing in the steering housing. Forces which act on the toothed rack outside the axle produce tilting moments of the toothed rack which have to be absorbed by the bearing. The bearing is further subjected to temperature influences, which during operation as a result of the different thermal expansion coefficients of the bearing shells and the steering housing, lead, for example, to a formation of gaps in the region of the bearing seat or damage to the components if they are not compensated for.

It is known to use angular ball bearings for supporting the ball nut. Angular ball bearings may absorb high axial and tilting forces without becoming damaged. However, compared with simple ball bearings they can only be produced with a high level of complexity and are therefore relatively expensive.

From the laid-open patent DE 10 2007 048 075 A1 a ball screw drive is known with a single-row bearing which is cushioned at one side. The spring which lies at one side against the bearing is intended to compensate for tilting moments and a thermal expansion and at the same time to fix the bearing in the housing.

The laid-open patent US 2015/0183455 A1 discloses two angular ball bearings for supporting a ball nut of a ball screw drive. The bearings in each case comprise a bearing inner ring and a bearing outer ring, between which balls are arranged. The two bearing outer rings are supported at one side in a state cushioned on the housing. In this instance, it is disadvantageous that no adequate thermal compensation can take place.

An object of the present invention is to provide an electromechanical servo-assisted power steering system having a ball screw drive in which the ball nut is supported in a bearing which comprises an improved tilting resistance and which can transmit high axial forces, wherein thermal expansions can be compensated for.

This object is achieved with an electromechanical servo-assisted power steering system having the features of claim 1. Other advantageous embodiments of the invention can be derived from the dependent claims.

Accordingly, there is provided an electromechanical servo-assisted power steering system, in particular for a motor vehicle, having a servomotor which drives an axially displaceable structural element by means of a ball nut which is rotatably supported in a bearing in a housing, wherein the ball nut is in engagement with a threaded spindle which is constructed on the structural element, wherein the bearing is a dual-row angular ball bearing having at least one bearing inner ring and at least one bearing outer ring, wherein the at least one bearing outer ring is received in a sleeve which is arranged in a bearing seat of the housing.

The angular ball bearing improves the tilting resistance of the bearing of the ball nut and can transmit high axial forces. The sleeve may compensate for different thermal expansions of the components.

Preferably, the contact angles of the dual-row angular ball bearing are selected in such a manner that a support spacing is formed. The tilting resistance is thereby further increased. It is advantageous for the contact angles of both rows of the angular ball bearing to be identical.

In an advantageous embodiment, two bearing outer rings are provided, wherein the bearing inner ring is in one piece. In this instance, it is preferable for the one-piece bearing inner ring to be formed by the ball nut.

Preferably, the sleeve is produced from plastics material.

It is further preferable for an ondular washer to be arranged so as to be surrounded by the sleeve, which in a state located between the sleeve and bearing outer ring, damps an axial movement of the structural element.

The structural element is preferably a toothed rack of a rack-and-pinion steering gear.

An embodiment of the present invention is described below with reference to the drawings. Components which are the same or components which have the same functions have the same reference numerals. In the drawings:

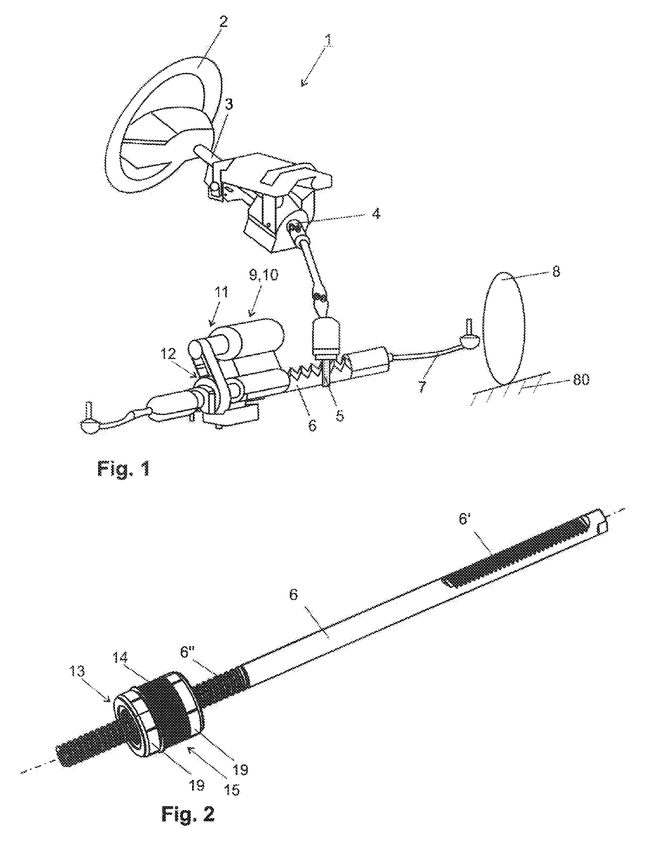

FIG. 1: is a schematic illustration of an electromechanical servo-assisted power steering system with a ball screw drive;

FIG. 2: is a three-dimensional illustration of a ball screw drive according to the invention without the surrounding housing;

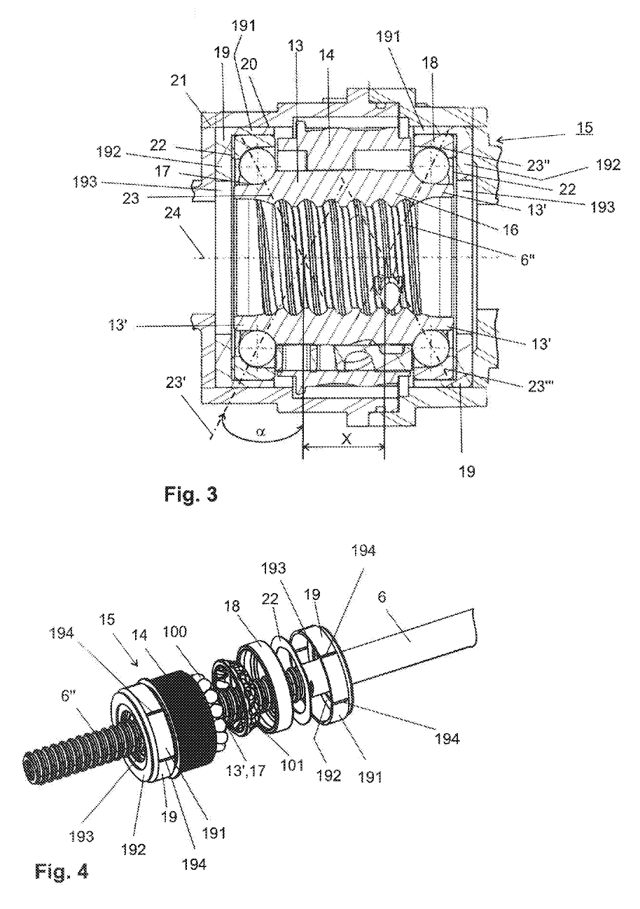

FIG. 3: is a longitudinal section through the angular ball bearing according to the invention, and

FIG. 4: is a partially exploded illustration of the angular ball bearing of the ball screw drive according to FIGS. 2 and 3.

FIG. 1 schematically illustrates an electromechanical motor vehicle steering system 1 having a steering wheel 2, which is coupled to an upper steering shaft 3 and a lower steering shaft 4 in a rotationally secure manner. The upper steering shaft 3 is functionally connected to the lower steering shaft 4 by means of a torsion bar. The lower steering shaft 4 is connected to a pinion 5 in a rotationally secure manner. The pinion 5 meshes in a known manner with a tooth segment 6′ of a toothed rack 6. The toothed rack 6 is supported in a steering housing so as to be able to be displaced in the direction of the longitudinal axis thereof. At the free end thereof, the toothed rack 6 is connected to tie rods 7 by means of ball joints which are not illustrated. The tie rods 7 themselves are connected in a known manner by means of axle members to an articulated wheel 8 of the motor vehicle in each case. A rotation of the steering wheel 2 leads via the connection of the steering shaft 3, 4 and the pinion 5 to a longitudinal displacement of the toothed rack 6 and consequently to a pivoting of the steered wheels 8. The steered wheels 8 are subjected via a roadway 80 to a retroaction which counteracts the steering movement. In order to pivot the wheels 8, a force which makes a corresponding torque on the steering wheel 2 necessary is consequently required. An electric motor 9 of a servo unit 10 is provided in order to support the driver during this steering movement. To this end, the electric motor 9 drives via a belt drive 11 a ball nut 13 of a ball screw drive 12. A rotation of the nut 13 moves the threaded spindle of the ball screw drive 12, which is part of the toothed rack 6, in an axial movement, which ultimately brings about a steering movement for the motor vehicle.

Even though in this instance, in the example, an electromechanical servo-assisted power steering system is illustrated with mechanical coupling between the steering wheel 2 and steering pinion 5, the invention can also be used for motor vehicle steering systems in which no mechanical coupling is present. Such steering systems are known as Steer-by-Wire systems.

In FIG. 2, the ball screw drive is illustrated in three dimensions. A threaded spindle 6″ is part of the toothed rack 6 and is arranged spaced apart from the tooth segment 6′. The ball nut 13 comprises a pulley 14 at the outer peripheral face thereof.

In FIG. 3, the ball nut 13 and the threaded spindle 6″ are illustrated in a longitudinal section. The ball nut 13 is rotatably supported in a dual-row angular ball bearing 15. The bearing 15 comprises a single common inner ring 16 which is formed by the ball nut 13. To this end, the ball nut 13 comprises at the ends 13′ thereof on the outer peripheral face 16 thereof a circumferential recess 17 for a ball raceway. The recess 17 or the raceway profile is in this instance constructed in accordance with an angular ball bearing. The bearing 15 further has two outer rings 18. The outer rings 18 are spaced apart from each other and are received in each case in a separate sleeve 19 which is arranged in each case in a bearing seat 20 of the housing 21. On the ball nut 13, the pulley 14 of the toothed belt drive 11 is fixed in a rotationally secure manner. The sleeve 19 is preferably formed from a material which has a greater thermal expansion than aluminum and steel. In particular, the sleeve 19 is preferably formed from a plastics material, in a particularly preferred manner from PA66GF30 (Polyamide 66 with glass fiber reinforcement at 30% volume proportion). It compensates for thermal expansions between the gear housing 21 and the ball screw drive 12.

Preferably, the sleeve comprises a circular-cylindrical peripheral wall 191, which surrounds the bearing 15 and the bearing axle 24, and a circular-cylindrical base region 192 which extends radially inward in the direction of the bearing axle 24 and comprises a circular-cylindrical opening 193 which surrounds the bearing axle 24. The two separate sleeves 19 are in this instance preferably arranged in such a manner that the two bearings 15 are arranged between the two base regions 192. Preferably, the base regions 192 are constructed in a planar manner with a preferably constant thickness. However, it is also conceivable and possible to provide the base regions in a selective manner with grooves, engravings or ribs or an undulating shape in order, for example, to influence the lubrication and/or thermal properties in a selective manner.

In order to further improve the compensation properties, the sleeve may comprise recesses in the peripheral wall 191 thereof, preferably slots 194 which extend in the direction of the bearing axle 24. These slots preferably run as far as the open end of the peripheral wall 191 which is directed away from the base region 192. That is to say, the slots 194 are open in the direction of the pulley 14.

The sleeve 19 is preferably formed in an integral manner from a single component, preferably integrally from a single material, in a particularly preferred manner with an injection-molding method.

As illustrated in FIG. 4, there is arranged in the sleeve 19 an ondular washer 22 which pretensions the bearing 15. The ondular washer 22 is located between the sleeve 19 and bearing outer ring 18. As a result of the combination of sleeve 19 and ondular washer 22, the connection resistance can be adjusted. In addition, this combination enables a damping of the movement of the bearing 15 in the event of dynamic loads. Depending on the application, however, this ondular washer 22 can be replaced by a plate spring or by a combination of plate spring and ondular washer.

The balls 100 of the angular ball bearing 15 are guided in a ball cage 101.

The raceways of the dual-row angular ball bearing 15 are constructed in such a manner that the connection lines 23, 23′, 23″, 23′″ of the contact locations between the ball and raceways intersect the bearing axle 24 located between the outer rings 18. Between the two intersection locations with the bearing axle 24, a predefined support spacing X is formed. As a result of the support spacing X, the bearing 15 is particularly tilt-resistant. The angle which a connection line of the two contact locations forms between the ball 100 and raceways with the radial plane and at which the loading is transferred from one raceway to the other is referred to as the contact angle α. The contact angle is intended in this instance to be understood to be the angle at which the connection lines intersect with the bearing axle, wherein the connection lines starting from the center of the balls of the respective angular ball bearing extend through the respective contact to the running surface of the bearing inner ring. The intersections of the connection lines with the bearing axle of the two rows of the dual-row angular ball bearing form the support spacing with respect to each other, measured on the bearing axle.

In the case where the balls are in double contact with the bearing inner ring, the bisector of the two contact connecting lines, run from by way of the respective contact and the respective center point of the ball, is defined as a connecting line.

Preferably, this support spacing is in a range from a minimum of the single diameter of the balls of the angular ball bearing to three times the diameter of the balls of the angular ball bearing. However, it is preferable for this support spacing to be constructed in a range between 1.5 times to 2.5 times and, in a particularly preferred manner, twice the diameter of the balls of the angular ball bearing. In the event that the two bearings of the angular ball bearing have different ball diameters, the smaller ball diameter may be considered to be the scale.

Preferably, the contact angle for both rows of the bearing 15 is of the same size. With a predefined value of the support spacing X, at a specific contact angle α the optimum tilting resistance of the bearing 15 can be adjusted.

The bearing 15 of the ball nut 13 is constructed in such a manner that the ball return 25 or the redirection member 26 can be arranged between the ball nut 13 and pulley 14. The ball return or the redirection member 26 consequently has space inside the dual-row bearing, whereby the arrangement becomes particularly compact.

The bearing according to the invention has an improved tilting resistance compared with conventional bearings. It can transmit high axial forces and in addition compensate for thermal expansions by means of the sleeve.

Furthermore, as a result of the use of the sleeve, the noise properties of the steering system are also improved.

1.-9. (canceled)

10. An electromechanical servo-assisted power steering system for a motor vehicle comprising a servo motor that drives an axially displaceable structural element by way of a ball nut that is rotatably supported in a bearing in a housing, wherein the ball nut is engaged with a threaded spindle constructed on the structural element, wherein the bearing is a dual-row angular ball bearing having a bearing inner ring and a bearing outer ring, wherein the bearing outer ring is received in a sleeve disposed in a bearing seat of the housing.

11. The electromechanical servo-assisted power steering system of claim 10 wherein the sleeve is configured to compensate for thermal expansions between the housing and the ball nut.

12. The electromechanical servo-assisted power steering system of claim 10 wherein contact angles of the dual-row angular ball bearing are configured such that a support spacing is formed.

13. The electromechanical servo-assisted power steering system of claim 12 wherein the contact angles of both rows of the dual-row angular ball bearing are identical.

14. The electromechanical servo-assisted power steering system of claim 10 wherein the bearing outer ring is a first bearing outer ring, the electromechanical servo-assisted power steering system comprising a second bearing outer ring, wherein the bearing inner ring is one piece.

15. The electromechanical servo-assisted power steering system of claim 14 wherein the bearing inner ring is formed by the ball nut.

16. The electromechanical servo-assisted power steering system of claim 10 wherein the sleeve comprises plastic.

17. The electromechanical servo-assisted power steering system of claim 10 wherein an ondular washer is disposed in the sleeve, wherein in a state between the sleeve and the bearing out ring the ondular washer damps axial movement of the structural element.

18. The electromechanical servo-assisted power steering system of claim 10 wherein the structural element is a toothed rack of a rack-and-pinion steering gear.
